(19) United States
(12) Patent Application Publication
(10) Pub. No.: US 2009/0110802 A1
(43) Pub. Date: Apr. 30, 2009

(54) METHOD FOR PREPARING PLASTICISED WHEAT GLUTEN COMPOSITIONS FOR PETFOOD AND PET TREAT APPLICATIONS

(76) Inventors: Patrick Pibarot, Guillaucourt (FR); Pierre Reynes, Pont de Metz (FR); Andreas Redi, Zevergem (BE); Geert Maesmans, Herent (BE); Wim Scheerlinckx, Dendeleeuw (BE)

Correspondence Address: BELL, BOYD & LLOYD LLP, P.O. Box 1135, CHICAGO, IL, 60690, US

(21) Appl. No.: 11/995,653

(22) PCT Filed: Jun. 30, 2006
(86) PCT No.: PCT/EP2006/006367

§ 371 Date: Jul. 21, 2008

(30) Foreign Application Priority Data
Jul. 14, 2005 (EP) 05015356.8

(51) Int. Cl. A23J 3/18; A23K 1/18

(52) U.S. Cl. 426/656

(57) ABSTRACT

A method for manufacturing plasticised gluten compositions for pet food and pet treat applications, the method comprising the steps of: mixing at least gluten and a plasticiser wherein the mixing equipment is set to a value below 500C and the SME (Specific Mechanical Energy) applied to the mix is less than 600 kj/kg, wherein the gluten content is between 20 and 85% by weight wherein the plasticiser content is less than 40% by weight. The invention also relates to the use of plasticised gluten for the manufacture of a chewy pet food having a high breaking force.

### FIELD OF THE INVENTION

The subject of this application are improved methods for preparing plasticised vital wheat gluten compositions having improved flexibility regarding transformation, in pet food or pet treats applications such as a chewy pet food.

### STATE OF THE ART

Plasticised wheat gluten compositions for human and animal food have been previously described in the prior art. Gluten is a protein and has been described as a high molecular weight polymer (Wrigley, et al. 1996. Glutenin polymers—Natures largest proteins. Royal Australian Chemical Institute: North Melbourne, Australian p. 316), where glutenin subunits are linked by interchain disulfide bonding of cysteine residues. (Graveland, A. et al. 1985. A model for the molecular structure of the glutenins from wheat flour. J. Cereal Sci. Vol. 3:1-6).

Moreover, previously documented is the fact that gluten is considered a glassy polymer that has a glass transition temperature which may depend on plasticiser content and pressure (Hoseney, R. C., et al. 1986. Wheat gluten: a glassy polymer. Cereal Chem. 63:285-286). The glass transition temperature of wheat gluten plasticised with water, glycerol or sorbitol has also been studied (Gontard, N. et al. 1999. Glass Transition of Wheat Gluten Plasticised with Water, Glycerol or Sorbitol. J. Agric. Food Chem. 47:538-543). Gluten may also form films as described by Gontard, N. et al. in Journal of Food Science, 1993, 58, p. 203-211. Furthermore, gluten viscosity will not decrease upon heating but instead will level off or increase due to cross-linking reactions. (Attenburrow et al., Rheological properties of wheat gluten. 1990. J. Cereal Sci. 12:1-14).

Knowledge of the cross-linking reactions is important to understanding thermoplastic extrusion processing. The formation of the final molecular network formed with gluten and glycerol (as a plasticiser) involves the disassociation and unfolding of the macromolecules, which allow them to recombine and to crosslink through specific linkages. (Redl, A., et al. 1999. Rheological properties of gluten plasticised with glycerol: dependence on temperature, glycerol content and mixing conditions. Rheol. Acta 38:311-320.) Therefore, it is known that glycerol has a plasticising effect on gluten.

The combination of gluten with glycerol has been used in a variety of foods. In U.S. Pat. No. 6,007,858 glycerol is used a humectant to preserve gluten. In this patent, up to 15% wheat gluten was mixed with glycerol or maltodextrin to prepare tamale rolls.

WO 0008944 describes a composition for the preparation of chewing gums. Plasticised proteinaceous materials are disclosed which are prepared by a batch process or prepared continuously by mixing the protein with a plasticiser. Batch processing is performed by utilising a Brabender Torque rheometer (high shear batch mixing). Continuous plasticisation is performed by utilising a counter-rotating conical twin-screw extruder. Typical processing conditions utilised thereby are a processing temperature of 70° C.-100° C., and a processing torque of 500 to 3000 mg. Among the different proteinaceous materials, zein and wheat gluten are cited as the preferred proteinaceous materials. The materials are used as an ingredient for preparing non-sticking chewing gum. WO 02/41701 and EP 1 066 759 A1 also describe the use of gluten in the manufacture of chewable compositions and chewable products.

Retort-stable food pieces comprising gluten are disclosed in U.S. Pat. No. 5,456,934. Furthermore, a dry pet food having a meat-like structure made from proteinaceous adhesives such as alkali modified wheat gluten is known from GB 1 433 976.

The object of U.S. Pat. No. 6,818,245 is to provide a digestible degradable gluten composition that can be stored for a prolonged period of time without degradation and used as a gum base for chewing gums. This object was realised by developing vital wheat gluten in a non-aqueous medium (i.e. a medium having an a_{w}<0.8). In a typical preparation, vital wheat gluten and a plasticiser are mixed together from 5 minutes to an hour at a temperature between 50° C. and 90° C., typically 58° C., in a mixer until 75% of the maximum torque is obtained. Mixing must be stopped when 75% of the torque value is reached so there is not a loss in mechanical properties of the gluten mixture, e.g., to allow the gluten to unfold, and to restore their interactions, i.e. H-bridges, hydrophobic and ionic bonds, sulphur bridges and cross-links. The ratio of vital wheat gluten compared to “non-aqueous” medium is 20:80 and 60:40. In the majority of the examples cited in this patent utilised 50% vital wheat gluten mixed with 50% glycerol.

Other work on the behaviour of vital wheat gluten plasticised with glycerol was performed by A. Redl, S. Guilbert, et al. The results of that work were published in several scientific journals, such as “Rheological properties of gluten plasticised with glycerol: dependence on temperature, glycerol content and mixing conditions”, Rheologica Acta Vol. 38: 311-320 (1999). This article describes using a Haake batch mixer to provide specific mechanical energy (SME) to a mixture of gluten and glycerol from 4.5 to 32.5 minutes to determine the affects of torque on batch mixing. The Glycerol content varied from 30-60% and the higher levels of glycerol required larger SME values. The range of SME varied from 1000-2000 KJ/Kg. Further the operating temperature was maintained at 80° C.

The publications Les Cahiers de Rhéologie, (1997), p. 339-347, and J. Agric. Food Chem. (1999), vol. 47, p. 538-543 are related to the preparation of glycerol-plasticised wheat gluten compositions utilising torque to develop a dough. Thereby it is observed that as the torque increases, the gluten/glycerol blend, originally showing the consistence of a sand/water blend, changes its consistency into a cohesive plastic and very sticky dough. When the maximum torque is surpassed, the gluten/glycerol dough aspect changes into a fairly glossy, non-sticky and very elastic material. The temperature change in the gluten/glycerol blends during mixing is characterised by a sigmoid shape curve with the turning point at the maximum torque.

Furthermore it is observed that, to a certain extent, these temperature increases result in irreversible changes of the plasticised material whereby the final product obtained may no longer be suitable for the applications mentioned above. The ratio between gluten and plasticiser in these applications varies between 75:25 and 60:40.

In Cereal Chemistry, 1999, vol. 76, p. 361-369, by the same authors, the extrusion of wheat gluten plasticised with glycerol is discussed. This publication concludes that extrusion at low barrel temperatures (<60° C.) is limited because of increasing viscosity. The increase in viscosity causes the die pressure and torque to increase past the limits of the extruder. It is further observed that specific mechanical energy input (SME) is at least 638 kJ/kg as disclosed in table I of that same publication.

In order to obtain plasticised wheat gluten compositions, a common denominator in the above cited prior art is the use of dough development conditions or shear mixing conditions that result in torque and temperature increases of the composition during processing.

Because wheat gluten becomes more reactive at increasing temperatures, cross-linking occurs, and as a result thereof, viscosity of the plasticised material further develops.

As a result of these conditions, the products obtained by these prior art processes do show a number of shortcomings, such as:
diminished transformation possibilities: irreversible changes occurring in the plasticised mass, make that if this mass needs to be reshaped, it must undergo a thermal treatment whereby the temperature now required will exceed the temperature of the previous processing step,
and/or a relatively low extensibility: due to the auto-catalytic process, the plasticised mass may become more and more rigid (reduced elongation at break, reduced flexibility), while tear strength increases,
And/or increased plasticiser content: this compensates to a certain extent loss in transformation possibilities and provides some flexibility with regard to mechanical properties.

As a result of the above cited shortcomings, the degree of incorporation of prior art plasticised wheat gluten in food, feed and non-food applications is limited.

Furthermore, U.S. Pat. No. 2,586,675 describes a method of making a chewing gum that utilises gluten and glycerin to prevent the gum from hardening and drying out. The gum is maintained in an elastic and chewable state by combining 50-85% gluten with 15-30% glycerin, a sweet substance, and allowing the mixture to ripen from 1 to 6 hours for the plasticiser to penetrate the gluten. However, the process for obtaining such a plastic material is quite lengthy and difficult to put into practice in an industrial environment.

In view of the above cited prior art, the problem to be solved is therefore to provide an improved process for preparing plasticised gluten compositions for application in pet food and pet food treats.

### SUMMARY OF THE INVENTION

Accordingly, the object is solved according to the independent claims. The dependent claims further develop the central idea.

Thus, in a first aspect, the present invention proposes a method for manufacturing plasticised gluten compositions for pet food or pet treat applications, the method comprising the steps of:
mixing at least gluten and a plasticiser
wherein the mixing equipment is set to a value below 50° C. and the SME (Specific Mechanical Energy) applied to the mix is less than 600 kJ/kg,
wherein the gluten content is between 20 and 85% by weight
wherein the plasticiser content is less than 40% by weight.

In a second aspect, a pet food obtainable by the method of the invention is provided.

A chewy pet food or pet treat obtainable by mixing at least gluten and a plasticiser by applying a SME of less than 250 kJ/kg, wherein the content of the plasticiser is below 40% by weight of the total mixing mass, falls under a further aspect of the invention.

The invention provides, in a further aspect, for a chewy dog food treat, comprising plasticised gluten being composed of 55-75 parts by weight of gluten and 35-20 parts by weight of a plasticiser, the treat having a maximum elongation value of 200 to 750% and a chewing time, when chewed by dogs, of at least 15 minutes.

A chewy pet food treat comprising plasticised gluten, having a maximum breaking force in the range of 200 to 850N, is provided by another aspect of the present invention.

### DETAILED DESCRIPTION OF THE INVENTION

Preferably the pet food or pet treat compositions of the invention contain a low plasticiser content (e.g. below 40% by weight of the plasticised material), whereby the plasticised material does show good cohesive properties, high extensibility and easy transformation properties.

The origin of the gluten is preferably wheat or other cereals. Modified gluten such as e.g. gluten which has undergone physical, chemical or enzymatic treatment, may be also be used. Cohesive properties are thereby reflected by stress-at-break values and extensibility by elongation-at-break values.

Easy transformation properties are reflected by the possibility to shape/reshape the plasticised material at temperatures below 70° C.

This has now been realised by the process according to the present invention.

The invention proposes a process for preparing plasticised wheat gluten compositions for pet food or pet treat applications, composed of 20-85 parts by weight of vital wheat gluten and less than 40 parts by weight of a plasticiser whereby
The wheat gluten and plasticiser can be fed into a continuous mixing device, and
the components can be mixed and homogenised at relatively low temperatures and with a low content of plasticiser,
whereby the specific mechanical energy input (SME) is less than 600 kJ/kg.

The present invention thus proposes a method for manufacturing plasticised gluten compositions for pet food or pet treat applications, the method comprising the steps of:
mixing at least gluten and a plasticiser
wherein the mixing equipment is set to a value below 50° C. and the SME (Specific Mechanical Energy) applied to the mix is less than 600 kJ/kg,
wherein the gluten content is between 20 and 85% by weight
wherein the plasticiser content is less than 40% by weight.

Preferably, the SME is less than 200 kJ/kg. In a more preferred embodiment, the mixing is carried out with a SME of more than 75 kJ/kg, preferably more than 150 kJ/kg, most preferably 150 kJ/kg.

The mixing is preferably carried out continuously using a continuous mixing device.

E.g. the mixing and homogenisation is carried out by means of a mixing screw configuration allowing mixing and homogenisation.

In the process of the invention, the temperature of the equipment is set at a temperature below 50° C., preferably between −10° C. and 45° C., more preferably between −10° C. and 0° C.

The advantage of these low-temperature conditions and/or low mechanical energy conditions is that the gluten molecules do not unfold. At least the gluten molecules unfold without breaking the intermolecular and intramolecular disulfide bonds, thus maintaining the elasticity such that the final state of the molecule is still springy.

The plasticiser may be selected from the group of polyhydroxy alcohols, starch hydrolysates, lower fatty acids (C2 up to C12), hydroxyalkylamines, hydroxy acids, polycarboxylic acids, urea and mixtures thereof.

The polyhydroxy alcohols are selected among glycerol, ethylene glycol, propylene glycol, di-ethylene glycol, tri-ethylene glycol, sugar alcohols, any mixtures thereof and may contain up to 30% by weight of water. The sugar alcohols are selected among glucose, fructose, saccharose, sorbitol, maltitol, xylitol, mannitol, lactitol, erythritol, isomalt, hydrogenated starch hydrolysates and mixtures thereof.

The preferred polyhydroxy alcohols used are selected among glycerol, ethylene glycol, propylene glycol, di-ethylene glycol and tri-ethylene glycol, glycerol being the most preferred.

The hydroxy acids may be selected among lactic acid, malic acid or tartaric acid, gluconic acid, and salts thereof.

The polycarboxylic acids are selected among succinic acid, adipic acid, citric acid, isocitric acid, glucaric acid and salts thereof.

These plasticisers can be used separately or in combinations.

In the process of the invention, the plasticiser content is preferably between 15 and 40%. More preferably, the plasticiser content is below 35%, even more preferably it is below 30%, more preferably still, it is below 25%. Most preferably, the plasticiser content is more than 20%.

The wheat gluten material as such may show some variability in rheological properties, as illustrated by Alveograph measurements, or by Brabender Plastograph measurements. These variations are due to the origins of the wheat raw material used, to variations in harvest conditions, and to variations in processing conditions.

In the process of the invention, the gluten content is preferably between 60 and 85% by weight.

Suitable continuous mixers can be selected among continuous screw mixers, continuous ribbon blenders and extruders equipped with a screw configuration allowing mixing without substantial mechanical energy input. Such types of screw configurations are known to the skilled technician.

In a preferred embodiment an extruder is used containing the required screw configuration. When using an extruder, it is advantageous to set the barrel and screw temperature between −10° C. and 45° C. As a result thereof the barrel temperature at the mixing screw section should not surpass 60° C., preferably 50° C. At the same time the temperature of the materials exiting the continuous mixing unit will not surpass 90° C., preferably 80° C. It should be noticed that the temperature applied to the barrel is aimed to limit the temperature increase.

In another advantageous embodiment, the plasticised wheat gluten material is composed of 65-75 parts by weight vital wheat gluten and 35-25 parts by weight of plasticiser.

In a preferred embodiment the plasticiser is glycerol. This glycerol may contain up to 20% water.

Depending on the processing conditions in combination with the quantities of ingredients used, a variety of suitable plasticised materials can be obtained. A pet food according to the invention may be obtained by the method described herein. The properties of these compositions may vary from homogeneous, plastic and deformable to tough, rubber-elastic and highly extensible.

The plasticised compositions exiting the continuous mixing device can be used as such or further processed and shaped. Further processing and shaping may be performed by e.g. compression moulding, calendering, lamination transformation and/or by microwave treatment.

Compared to the compositions of the prior art cited above, less extreme processing conditions (temperature and specific mechanical energy input SME) are needed to obtain well shaped rubber-elastic products. At the same time the intermediate and end-materials may comprise less plasticiser and more gluten protein. A reduced plasticiser content may be advantageous in a number of food and/or feed applications were a too high content of low MW polyol plasticiser is not desirable (e.g. pet foods, chewy confectionery, meat imitations, etc.). The desirable content of low molecular weight polyols such as glycerol and propylene glycol in these applications is typically below 25% by weight, preferably below 20% by weight of the final compositions.

In a further aspect of the invention, compositions can be prepared by combining a range of products with the plasticised wheat gluten prepared according to the process of the invention. These products can be added in an amount between 0.1-40% by weight of the composition, during or after the step of preparing the plasticised wheat gluten. More preferably these products can be added in an amount between 0.5-25% and most preferably between 1-15% by weight of the composition.

These products may be selected among the by-products obtained during processing of agricultural or forest raw materials, polysaccharides and derivatives thereof, other proteins of vegetable or animal origin, mineral compounds, biomass, fermented materials, and/or mixtures thereof.

The agricultural by-products may comprise by-products from the wet and/or dry-milling of cereals, in particular maize and wheat, from the processing of oleaginous materials, including but not limited to soy, sunflower or rapeseed, from the processing of other major crops such as, but not limited to, sugar cane, sugar beet, potato, or tapioca.

Polysaccharides include but are not limited to starches in native or modified form, cellulose and derivatives thereof, beta glucans, inulin-type polysaccharides, pectins, arabinoxylans, plant gums or microbial gums.

Other proteins include but are not limited to e.g. soy concentrates and isolates, leguminous proteins, casein and derivatives thereof, whey proteins, fish proteins, or animal proteins including plasma proteins.

Further, also additives can be incorporated, such as colouring or flavouring additives, amino acids, peptides, vitamins, stabilisers, and/or emulsifiers.

In a particular embodiment of the invention, chewy treats for pet animals are prepared comprising the plasticised wheat gluten obtained by the process of the invention. These compositions may further contain up to 20% additional ingredients belonging to the products disclosed in the previous paragraphs.

The materials thus obtained are characterised by their high flexibility in combination with long chewing times.

The invention for the first time proposes to use plasticised gluten for producing a chewy pet food treat. This is surprising insofar as a chewy pet food treat has physical properties which are completely different to those of a chewing gum. It has been especially surprising that the high breaking force necessary for a pet chew could be achieved using plasticised gluten.

Thus, a chewy pet food or pet treat obtainable by mixing at least gluten and a plasticiser by applying a SME of less than 250 kJ/kg, wherein the content of the plasticiser is below 40% by weight of the total mixing mass is provided by the invention.

The physical parameters which differentiate a chewy gum from a pet chew such as a chewy pet food treat are e.g.:

| | Pet Chew | Chewing Gum |
|---|---|---|
| Elongation: | 300 to 900% | 1000 up to over 2000% |
| Breaking force: | 200 to 2000 N | <10 N |

Flexibility of the chewy treats of the invention is reflected by the elongation of a standard piece when submitted to a standardised tearing operation. Maximum elongation values of at least 200%, preferably at least 300% and more preferably at least 400% are obtained.

A chewy dog food treat according to the present invention comprises plasticised gluten being composed of 55-75 parts by weight of gluten and 35-20 parts by weight of a plasticiser, and has a maximum elongation value of 200 to 750% and a chewing time, when chewed by dogs, of at least 15 minutes.

Preferably, the dog food treat comprising plasticised gluten is composed of 65-75 parts by weight of gluten and 35-25 parts by weight of a plasticiser, the treat having a maximum elongation value of 200 to 650% and a chewing time, when chewed by dogs, of at least 20 minutes.

According to a preferred embodiment, the plasticiser used is glycerol.

According to a further aspect of the invention, a chewy pet food treat comprising plasticised gluten, having a maximum breaking force in the range of 200 to 850N is provided. Preferably, the pet food treat has a maximum breaking force in the range of 200 to 600 N, more preferably in the range of 200 to 400 N, even more preferably in the range of 200 to 350 N.

The pet food treat of the invention may comprise plasticised gluten which is composed of 50-75 parts by weight vital wheat gluten and 50-25 parts by weight of a plasticiser.

Preferably, the plasticised gluten in the pet food treat is composed of 55-75 parts by weight vital wheat gluten and 35-20 parts by weight of a plasticiser.

According to a further embodiment, the plasticised gluten may be composed of 60-70 parts by weight vital wheat gluten and 40-30 parts by weight of a plasticiser.

The pet food or pet treat of the invention has a maximum elongation value of 200 to 750%, preferably of 200 to 650%, more preferably of 300% to 400%.

The chewing time of the pet food or pet treat of the invention is of at least 15 minutes, preferably at least 20 minutes.

The invention will now be illustrated by a number of examples.

### EXAMPLES

### Materials:

Vital wheat gluten,(Amygluten 110 & 160) 94% d.s. Amygluten 160 has a dough development time of 10 min. as determined in a counter rotating batch mixer (Brabender Plastograph) while Amygluten 110 has a dough development time of 5 min. in the same conditions. These time values correspond to the maximum torque value measured in the plastograph while mixing a composition of 100 parts by weight gluten and 53 parts by weight glycerol.
Vital wheat gluten Protinax 132
Food grade glycerol (14% water content)

### Equipment:

Extrusion is performed with a co-rotating, self-wiping, twin-screw extruder with a barrel diameter (D) of 53 mm (Clextral Evolum 53). The extruder barrel consists of 10 zones of 212 mm length, each zone being equipped with an independent temperature control based on resistive heaters and water circulation in a double jacket. The feeding zone is cooled by water circulation. The total length of the screw is 40D. Each screw is composed of double flighted right-handed screw elements with different pitches. This allows developing viscosity as late as possible. Gluten powder is fed with a twin screw gravimetric feeder and glycerol with a metering pump.

Barrel temperature mentioned below was determined at the end of the screw (last barrel).

The SME value in the framework of the present invention has been determined according to the following equation:

SME=N/Nₘₐₓ*1/D*U*I*0.9

where:
N=screw speed read
Nₘₐₓ=maximal screw speed of the extruder
D=dry mix rate (kg/h)
U=armature potential difference on DC motor (V)
I=amperage consumption by the electrical motor (A)
0.9=coefficient taking in account losses between electrical motor and gear box

### Example 1-3

In the following examples a screw configuration containing only conveying elements was used. Two compositions of wheat gluten (Amygluten 160) and plasticiser were tested. The third composition was equal to example 2 except that a different gluten material is used (Amygluten 110).

| | Example 1 | | Example 2 | | Example 3 | |
|---|---|---|---|---|---|---|
| Extrudate | 61% | Amygluten 160 | 66% | Amygluten 160 | 66% | Amygluten 110 |
| composition (w/w) | 34% | glycerol | 28% | glycerol | 28% | glycerol |
| | 6% | water | 6% | water | 6% | water |

| | | | |
|---|---|---|---|
| Screw speed (rpm) | 220 | 220 | 220 |
| Throughput (kg/h) | 132 | 122 | 122 |
| Extrudate temp. | 65-70 | 70-75 | 65-70 |
| (° C.) | | | |
| Barrel temp. (° C.) | 45 | 50 | 45 |
| SME (kJ/kg) | 211 | 228 | 210 |
| A_{w} | 0.4 | 0.42 | 0.40 |
| Moisture (%) | 13 | 12 | 13 |
| Penetrometry (N) | 17 | 17 | 10 |
| Maximum Stress | 75 | 315 | 165 |
| (Breaking force) | | | |
| (N) | | | |
| Elongation at | 400 | 615 | 420 |
| break (%) | | | |

Traction measurement: speed 10 mm/min
Penetrometry test with cone 45°; penetration depth 6 mm

In the case of example 1, a homogeneous, plastic and deformable material was obtained. This material was moulded in a separate step, immediately after extrusion. After storing the moulded material for 24 hours at room temperature, a rubber-elastic product was obtained that could no longer be reshaped at room temperature.

In the case of example 2, lower plasticiser content resulted in a very elastic, extensible, rubber-like material that could not be further shaped by “cold” techniques such as lamination. However, cutting into any desired shape caused no problems, while hot molding allowed reshaping of the material. Mechanical properties however changed during hot molding, providing compositions still being elastic but tougher (higher E-modulus) and less extensible.

In example 3 the same conditions of example 1 are used. Amygluten 160 is replaced by Amygluten 110, having a shorter dough development time.

This resulted in a cohesive and very elastic, rubber-like material showing a very high extrudate swell (about 200%, calculated as extrudate diameter/die diameter*100). The material could be shaped by means of “cold” techniques such as lamination.

This illustrates that different types of vital wheat gluten can be used.

### Examples 4-6

Manufacturing examples whereby the last barrel elements are cooled with glycolated water (at −6° C.). All experiments were performed using Amygluten 160.

| | Example 4 | | Example 5 | | Example 6 | |
|---|---|---|---|---|---|---|
| Extrudate | 68% | Amygluten 160 | 72% | Amygluten 160 | 72% | Amygluten 160 |
| composition (% | 27% | glycerol | 24% | glycerol | 20% | glycerol |
| w/w) | 5% | water | 4% | water | 8% | water |

| | | | |
|---|---|---|---|
| Screw speed (rpm) | 190 | 190 | 190 |
| Throughput (kg/h) | 147 | 139 | 139 |
| Extrudate temp. | 70-75 | 80-85 | 75-80 |
| (° C.) | | | |
| Barrel temp. (° C.) | 38 | 51 | 46 |
| SHE (kJ/kg) | 121 | 208 | 158 |
| A_{w} | 0.46 | 0.46 | 0.60 |
| Moisture (%) | 11 | 11 | 13.5 |
| Penetrometry (N) | 35 | 63 | 37 |
| Maximum Stress | 320 | 380 | 260 |
| (Breaking force) | | | |
| (N) | | | |
| Elongation at | 460 | 340 | 310 |
| break (%) | | | |

Traction measurement: speed 10 mm/min
Penetrometry test with cone 45°; penetration depth 6 mm

In all three examples homogeneous, elastic rubber-like extrudates were obtained.

### Example 7, 8 & 9

### Chewy Treats for Pets

Manufacturing examples whereby the last barrel elements are cooled with glycolated water (at −6° C.).

Extrusion parameters, recipe and characterisations of extrudates are presented in table 1, 2 & 3.

Shape of extrudates produced was a cylinder (diameter: 55 mm/length: 150 mm).

TABLE 1
Example 7

| | | |
|---|---|---|
| Extrudate Composition (w/w) | 54.2% | Amylogluten 160 |
| | 22.5% | Glycerol |
| | 11.9% | Water |
| | 11.4% | others dry ingredients |

| | |
|---|---|
| Screw speed (rpm) | 190 |
| Throughput (kg/h) | 122 |
| Extrudate temperature (° C.) | 70-75 |
| Barrel 10 temperature (° C.) | 45 |
| SME (kJ/kg) | 167 |
| Aw | 0.66 |
| Moisture (%) | 16.8 |
| Penetrometry (N) | 50 |
| Maximum Stress (N) | 330 |
| Maximal Elongation (%) | 512 |
| Chewing time (min) (250 | 20 |
| g/piece) | |

TABLE 2
Example 8

| | | |
|---|---|---|
| Extrudate Composition (w/w) | 54.2% | Amylogluten 160 |
| | 22.5% | Glycerol |
| | 11.9% | Water |
| | 11.4% | others dry ingredients |

| | |
|---|---|
| Screw speed (rpm) | 190 |
| Throughput (kg/h) | 124 |
| Extrudate temperature (° C.) | 70-75 |
| Barrel 10 temperature (° C.) | 44 |
| SME (kJ/kg) | 185 |
| Aw | 0.64 |
| Moisture (%) | 15.9 |
| Penetrometry (N) | 55 |
| Maximum stress (N) | 340 |
| Maximal Elongation (%) | 490 |
| Chewing time (min) (250 | 25 |
| g/piece) | |

TABLE 3
Example 9

| | | |
|---|---|---|
| Extrudate Composition (w/w) | 54.2% | Protinax 132 |
| | 22.5% | Glycerol |
| | 11.9% | Water |
| | 11.4% | others dry ingredients |

| | |
|---|---|
| Screw speed (rpm) | 340 |
| Throughput (kg/h) | 298 |
| Extrudate temperature (° C.) | 70-75 |
| Barrel 10 temperature (° C.) | 47 |
| SME (kJ/kg) | 190 |
| Aw | 0.695 |
| Moisture (%) | 13.8 |
| Penetrometry (N) | 90 |
| Maximum stress (N) | 810 |
| Maximal Elongation (%) | 715 |
| Chewing time (min) (250 | 22 |
| g/piece) | |

### Method for Chewing Time Measurement

### Principle:

Dogs are fed a treat between 13.00 PM and 16.00 PM, i.e. 5 to 6 hours after receiving their main meal. The Treat is presented to the animal, given from hand to mouth. The chewing time as well as the occupation time can be measured. Comparison is made with a product of same size and weight, or the competitor target. The chewing time represents only the duration of biting, gnawing, chewing and ingesting the product.

### Testing Procedure:

### Animals:

All the dogs of the kennel may be used for the treat test. A pre-selection can be made to reject dogs that do not participate to the treat test. These dogs are spread as follows:
big dogs
medium dogs
small dogs

Within a sub-group of dogs, distribution of body weight, sex and ages must be balanced.

The breed of dog can be selected depending on the size of treat to be tested. In this case, only big dogs were selected (see below).

In a same breed, the dogs may be divided into different balanced sub-groups to test each product to be assessed the same day.

### Environment:

The Treat test is conducted in indoor kennel runs. Otherwise, dogs are housed in pairs in indoor/outdoor kennel runs. The temperature is maintained between 15-21° C. Dogs follow the natural nychtemeral cycle.

Tap water is provided ad libitum through automatic system. The usual dog's feeding pattern is not disturbed when testing treats, which is a Dry or Wet main meal given ad libitum during 30 min between 7.45 AM to 8.15 AM.

### Testing Design

When several products are compared one against the others, a latin square design is applied to cancel any order effect of the treat presentation, or any novelty effect of the first day, on Treats intake. In this case, there are as many panels participating in the study and experimental days as tested products (Table 4). In a week, a maximum of four products may be tested (4 experimental days).

TABLE 4
An example of latin square design for four
products testing (A vs B vs C vs D)

| | Day 1 | Day 2 | Day 3 | Day 4 |
|---|---|---|---|---|
| Group 1 | A | B | C | D |
| Group 2 | B | D | A | C |
| Group 3 | C | A | D | B |
| Group 4 | D | C | B | A |

### Materials

Some materials are needed to realise the Treat Test:
For each product to be tested: n Treats where n is the number of dog to be tested for day;
A timer ;
A result form

Chewing Time:

For each test, the number of dogs is determined for those who:
have been tested;
have rejected the product (not take in mouth, see above);
have participated to the test;

The chewing duration is determined over the dogs that have participated to the test. It sums all the time spent taking the product between paws, biting, gnawing, chewing as well as swallowing the pieces of Treats.

Chewing time was performed with 30 large dogs (weight>25 kg). The following breeds were used to perform the test: Labrador, German Pointer, Labrador, German Sheperd, Rottweiler, Bernese, Airdale Terrier, Golden Retriever and Dalmatian.

1. A method for manufacturing plasticised gluten compositions for pet food or pet treat applications, comprising the steps of:
mixing at least gluten and a plasticiser,
the mixing equipment being set to a value below 50° C. and the SME (Specific Mechanical Energy) applied to the mix is less than 600 kJ/kg,
the gluten content is between 20 and 85% by weight, and
the plasticiser content is less than 40% by weight.

2. The method according to claim 1, wherein the gluten content is between 60 and 85% by weight.

3. The method according to claim 1, wherein the mixing is carried out with a SME of less than 200 kJ/kg.

4. The method according to claim 1, wherein the plasticiser is glycerol.

5. The method according to claim 1, wherein the plasticiser content is between 15 and 40%.

6. The method according to claim 1, wherein the plasticiser content is below 35%.

7. The method according to claim 1, wherein the plasticiser content is below 30%.

8. The method according to claim 1, wherein the plasticiser content is below 25%.

9. The method according to claim 1, wherein the plasticiser content is more than 20%.

10. The method according to claim 1, wherein the mixing is carried out with a SME of more than 75 kJ/kg.

11. The method according to claim 1, wherein the temperature of the mixing equipment is set to a value of between −10° C. and 45° C.

12. The method according to claim 1, wherein the temperature of the mixing equipment is set to a value of between −10° C. and 0° C.

13. The method according to claim 1, wherein the mixing is carried out continuously.

14. A pet food obtainable by manufacturing plasticised gluten compositions for pet food or pet treat applications, comprising the steps of: mixing at least gluten and a plasticiser, the mixing equipment being set to a value below 50° C. and the SME (Specific Mechanical Energy) applied to the mix is less than 600 kJ/kg, the gluten content is between 20 and 85% by weight, and the plasticiser content is less than 40% by weight.

15. A chewy pet food or pet treat produced by mixing at least gluten and a plasticiser and applying a SME of less than 250 kJ/kg, wherein the content of the plasticiser is below 40% by weight of the total mixing mass.

16. A chewy dog food treat, comprising plasticised gluten comprising 55-75 parts by weight of gluten and 35-20 parts by weight of a plasticiser, the treat having a maximum elongation value of 200 to 750% and a chewing time, when chewed by dogs, of at least 15 minutes.

17. A chewy dog food treat according to claim 16, wherein the plasticised gluten is composed of 65-75 parts by weight of gluten and 35-25 parts by weight of a plasticiser, the treat having a maximum elongation value of 200 to 650% and a chewing time, when chewed by dogs, of at least 20 minutes.

18. The chewy dog food treat according to claim 16, wherein the plasticiser is glycerol.

19. A chewy pet food treat comprising plasticised gluten, having a maximum breaking force of 200 to 850N.

20. The chewy pet food treat according to claim 19, having a maximum breaking force of 200 to 600 N.

21. The chewy pet food treat according to claim 19, having a maximum breaking force of 200 to 400 N.

22. The chewy pet food treat according to claim 19, having a maximum breaking force of 200 to 350 N.

23. The chewy pet food treat according to claim 19, wherein the gluten is plasticised with a plasticiser containing glycerol.

24. The pet food treat according to claim 19, wherein the plasticised gluten is composed of 50-75 parts by weight vital wheat gluten and 50-25 parts by weight of a plasticiser.

25. The pet food treat according to claim 19, wherein the plasticised gluten is composed of 55-75 parts by weight vital wheat gluten and 35-20 parts by weight of a plasticiser.

26. The chewy pet food treat according to claim 19, wherein the plasticised gluten is composed of 60-70 parts by weight vital wheat gluten and 40-30 parts by weight of a plasticiser.

27. The chewy pet food treat according to claim 19, having a maximum elongation value of 200 to 750%.

28. The chewy pet food treat according to claim 19, having a maximum elongation value of 200 to 650%.

29. The chewy pet food treat according to 19, having a maximum elongation value of 300 to 400%.

30. The chewy pet food treat according to claim 19, the pet food being a chewy dog food treat having a chewing time of at least 15 minutes.

31. The chewy pet food treat according to claim 30, the pet food being a chewy dog food treat having a chewing time of at least 20 minutes.

32. Use of plasticised gluten for producing a chewy pet food treat, wherein the plasticised gluten is manufactured for pet food or pet treat applications, comprising the steps of: mixing at least gluten and a plasticiser, the mixing equipment being set to a value below 50° C. and the SME (Specific Mechanical Energy) applied to the mix is less than 600 kJ/kg, wherein the gluten content is between 20 and 85% by weight, and the plasticiser content is less than 40% by weight.

33. The method according to claim 1, wherein the mixing is carried out with a SME of more than 150 kJ/kg.
